(19) United States
(12) Patent Application Publication
(10) Pub. No.: US 2016/0077210 A1
(43) Pub. Date: Mar. 17, 2016

(54) TECHNIQUES FOR DETERMINING A SIGNAL SEARCH SPACE FOR A SATELLITE POSITIONING SYSTEM RECEIVER IN A MOBILE DEVICE

(71) Applicant: QUALCOMM Incorporated, San Diego, CA (US)

(72) Inventors: Guttorm R. Opshaug, Redwood City, CA (US); Ie-Hong Lin, Cupertino, CA (US); Aziz Gholmieh, San Diego, CA (US)

(21) Appl. No.: 14/483,906

(22) Filed: Sep. 11, 2014

(51) Int. Cl. G01S 19/03

(52) U.S. Cl. CPC G01S 19/03

(57) ABSTRACT

Disclosed are methods, devices and systems for determining a signal search space for acquisition of a satellite positioning system (SPS) signal. For example, a signal transmitted by a terrestrial-based transmitting device may be acquired for use, at least in part, to adjust a receiver for acquisition of SPS signals. The terrestrial-based transmitting device may be classified based, at least in part, on a factor obtained from the acquired signal. An SPS signal search space for the receiver may then be based, at least in part, on a frequency uncertainty corresponding to the classification of said transmitting device.

### BACKGROUND

1. Field

The subject matter disclosed herein relates to electronic devices, and more particularly to methods, apparatuses and articles of manufacture for a mobile device having a receiver capable of searching for and acquiring satellite positioning system (SPS) signals using a SPS signal search space that is determined based, at least in part, on a frequency uncertainty corresponding to determined classification of a terrestrial-based transmitting device.

2. Information

As its name implies, a mobile device may be moved about, e.g. typically being carried by a user and/or possibly a machine. By way of some non-limiting examples, a mobile device may take the form of a cellular telephone, a smart phone, a tablet computer, a laptop computer, a wearable computer, a navigation and/or tracking device, etc.

A position and/or movements of a mobile device may be determined, at least in part, by a positioning and/or navigation capability (herein after simply referred to as a positioning capability) that may be implemented on board the mobile device, in one or more other electronic devices, and/or some combination thereof. Certain positioning capabilities may be based on one or more wireless signals transmitted by one or more transmitting devices and acquired by mobile device. By way of example, certain wireless signal-based positioning capabilities make use of wireless signals acquired from a satellite positioning system (SPS), such as, e.g., the global positioning system (GPS), other global navigation satellite systems (GNSS), etc. GPS, for example, relies on measurements of propagation delays of signals transmitted from space vehicle (SV) transmitters to receivers (e.g., ground-based navigation receivers, mobile devices, etc.). By measuring such a propagation delay, a receiver may obtain a pseudorange measurement to an associated transmitting SV. By obtaining such pseudorange measurements to several SVs at known orbital positions relative to the earth, a receiver may compute an estimated location of the receiver as part of a navigation solution, for example.

To obtain pseudorange measurements to a transmitter on an SV, an SPS receiver may acquire an SPS signal transmitted by the transmitter according to a particular known format. Maintaining a clock synchronized with the SPS at least in part, the SPS receiver may measure a propagation delay based, at least in part, on detection of a time reference in the acquired SPS signal. To assist in acquisition of an SPS signal, a two-dimensional SPS signal search space may be defined at least in part by an uncertainty in time and an uncertainty in carrier frequency of the received SPS signal. An uncertainty in frequency may also be defined, at least in part, by an expected Doppler shift arising from relative movement as well as an uncertainty in the accuracy of a receiver frequency to be used in downconverting an acquired SPS signal to a baseband signal. Such techniques and the like are well known.

In certain implementations, a mobile device comprising an SPS receiver may adjust (tune) a receive frequency of the GNSS receiver based on or according to a carrier frequency of a signal acquired from a local terrestrial transmitter (e.g., cellular base station, etc.) used as a reference frequency. As a receive frequency of a SPS receiver may be referenced to such a carrier frequency, a frequency uncertainty in the SPS receiver may be affected by an uncertainty in the carrier frequency. Accordingly, it may be useful to consider such frequency uncertainty when determining an SPS signal search space.

### SUMMARY

Briefly, particular implementations are directed to a method at a mobile device comprising: acquiring a signal transmitted by a terrestrial-based transmitting device; determining a classification of said terrestrial-based transmitting device based, at least in part, on one or more factors obtained from said acquired signal; and determining a satellite positioning system (SPS) signal search space for a receiver based, at least in part, on a frequency uncertainty corresponding to said classification of said terrestrial-based transmitting device.

Another particular implementation is directed to an apparatus for use in a mobile device, the apparatus comprising: means for acquiring a signal transmitted by a terrestrial-based transmitting device; means for determining a classification of said terrestrial-based transmitting device based, at least in part, on one or more factors obtained from said acquired signal; and means for determining an SPS signal search space for a receiver based, at least in part, on a frequency uncertainty corresponding to said classification of said terrestrial-based transmitting device.

Another particular implementation is directed to a mobile device comprising: a communication interface to acquire a signal transmitted by a terrestrial-based transmitting device; and a processing unit to: determine a classification of said terrestrial-based transmitting device based, at least in part, on one or more factors obtained from said signal acquired via said communication interface; and determine an SPS signal search space for a receiver based, at least in part, on a frequency uncertainty corresponding to said classification of said transmitting device.

Another particular implementation is directed to a non-transitory computer readable medium having stored therein computer implementable instructions executable by a processing unit of a mobile device to: determine a classification of a terrestrial-based transmitting device based, at least in part, on one or more factors obtained from a signal transmitted by the terrestrial-based transmitting device and acquired by said mobile device; and determine an SPS signal search space for a receiver based, at least in part, on a frequency uncertainty corresponding to said classification of said transmitting device.

It should be understood that the aforementioned implementations are merely example implementations, and that claimed subject matter is not necessarily limited to any particular aspect of these example implementations.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an arrangement of representative electronic devices including a mobile device, a plurality of terrestrial-based transmitting devices, and a satellite positioning system (SPS), in accordance with an example implementation.

FIG. 2A and FIG. 2B are flow diagrams illustrating some example processes that may be implemented using a mobile device, for example, as in FIG. 1, to classify a terrestrial-based transmitting device based on one or more acquired signals, and possibly to affect an SPS signal search space based, at least in part, thereon, in accordance with certain example implementations.

FIG. 3 is process flow diagram illustrating an example process that may be implemented using a mobile device, for example, as in FIG. 1, to possibly select between a plurality of classifications that may be determined for a terrestrial-based transmitting device based on one or more acquired signals, in accordance with certain example implementations.

FIG. 4 is a schematic diagram illustrating certain features of an example special purpose computing platform that may be provisioned within a mobile device, for example, as in FIG. 1, and to possibly perform all or part of one or more of the processes presented herein, for example, as in FIG. 2A, FIG. 2B, or FIG. 3, in accordance with certain example implementations.

### DETAILED DESCRIPTION

Various techniques are described herein which may be implemented in a mobile device to determine a classification of a terrestrial-based transmitting device based on one or more signals transmitted by the terrestrial-based transmitting device and acquired by the mobile device. In certain instances, based on such a determined classification the mobile device may determine or otherwise affect an SPS signal search space for a receiver onboard the mobile device. For example, as described in greater detail herein, in certain instances a frequency uncertainty or another useful parameter may correspond to a determined classification, and such frequency uncertainty or another useful parameter may be used, at least in part, to possibly affect an SPS signal search space.

By way of an initial example, in certain implementations a mobile device may acquire a signal transmitted by a terrestrial-based transmitting device. In certain instances, all or part of such an acquired signal may be used in some manner to configure or otherwise adjust a receiver for acquisition of one or more SPS signals. Such a mobile device may, for example, determine a classification of the terrestrial-based transmitting device based, at least in part, on one or more factors that may be obtained from the acquired signal. For example, in certain implementations one or more factors (for example, one or more indications) may be encoded or otherwise carried in one or more acquired signals. In another example, in certain implementations one or more factors (for example, one or more signal characteristics) may be measured or otherwise based on one or more acquired signals. Such a mobile device may, for example, determine an SPS signal search space for a receiver based, at least in part, on a frequency uncertainty corresponding to determined classification of the transmitting device.

As described in greater detail herein, in certain example implementations, a classification of a terrestrial-based transmitting device may be selected from a plurality of classifications that may correspond to a plurality of different expected transmitter device quality ratings. If a mobile device is being served at a service range that is significantly beyond that of a femtocell transceiver, for example, it may be inferred that a terrestrial-based transmitting currently serving the mobile device is not a femtocell or picocell transceiver. By process of elimination, this particular terrestrial-based transmitter may be classified as a base station serving a macro cell transmitting a signal having a smaller frequency uncertainty.

By way of some non-limiting examples, in certain implementations selectable classifications for a terrestrial-based transmitting device may comprise a wide area BS classification, a medium range BS classification, a local area BS classification, a femto BS classification. As described in greater detail below, such example classifications may correspond to potential differences in an expected transmitter device quality rating, particular industry standards, and/or the like or some combination thereof. In certain example implementations, additional or other classifications may be provided for selection. For example, in certain instances a non-femto BS classification, and/or an unknown BS classification may be provided. In certain implementations, one or more other or additional selectable classifications may be provided that correspond to one or more particular device manufacturers, one or more particular device models, one or more generation designated devices/services, one or more service/network provider entities, and/or the like or some combination thereof, just to name a few examples.

One or more of the various classifications that may be selected using the example techniques presented herein may be, in certain instances, predefined, or dynamically defined (e.g., added, removed, modified). By way of example, one or more classifications may be defined via express updates from another device or computer readable medium, or possibly discovered/inferred over time via operation history/experience of the mobile device and/or other mobile device(s), etc. Similarly, in certain instances, a frequency uncertainty and/or other useful parameter corresponding to a particular classification may be predefined, or dynamically defined.

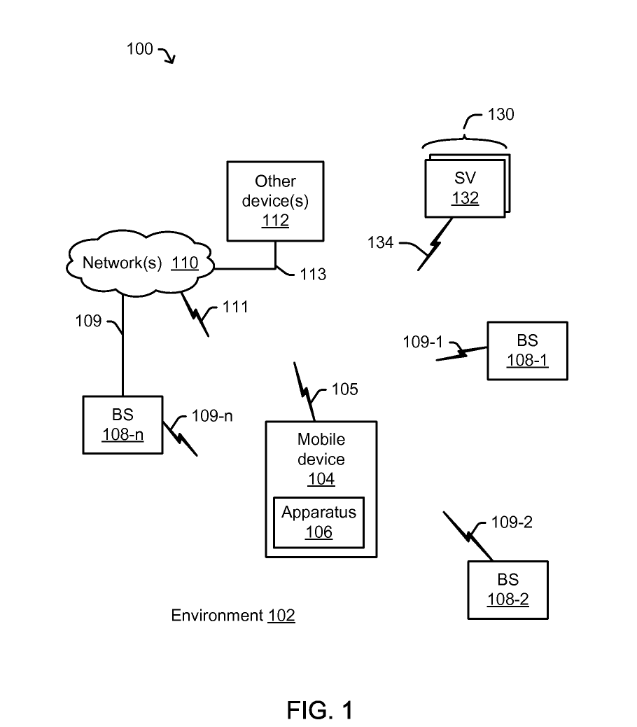

Attention is now drawn to FIG. 1, which is a schematic block diagram illustrating an example arrangement 100 comprising various example electronic devices within an environment 102. Environment 102 may comprise an outdoor space, one or more indoor spaces, and/or some combination thereof, in which a mobile device 104 may be located and moved about.

Mobile device 104 may be representative of any electronic device capable of being moved in some manner at least within environment 102. Hence, by way of example, mobile device 104 may comprise a cellular telephone, a smart phone, a tablet computer, a laptop computer, a wearable computer, a navigation and/or tracking device, etc. As illustrated, mobile device 104 may comprise an apparatus 106, which may be configured to provide and/or support in some manner one or more of the techniques provided herein. In certain instances, apparatus 106 may comprise hardware/firmware components, or possibly a combination of hardware/firmware and software components.

Accordingly, at times mobile device 104 may be capable of acquiring wireless signals (e.g., items 109-1, 109-2, . . . , 109-n) from one or more terrestrial-based transmitting devices, (e.g., as respectively represented by base stations (BSs) 108-1, 108-2, . . . , 108-n. For example, in certain instances, BS 108-1 may comprise a terrestrial-based transmitting device that may be classified as a wide area BS (e.g., a wide area base station in a WCDMA/LTE system, a macro base transceiver station in a GSM system, a macro cell in a cdma2000 system, etc.) having an expected service range that may extend over a vast region including all or part of one or more indoor space(s) and all or part of the outdoor space within environment 102. Hence, in such an example, mobile station 104 may be able to acquire signal 109-1 within example environment 102.

In another example, in certain instances, BS 108-2 may comprise a terrestrial-based transmitting device that may be classified as a medium range BS (e.g., a medium range base station in a WCDMA/LTE system, a pico base transceiver station in a GSM system, a pico cell in a cdma2000 system, etc.) having an expected service range that extends over a portion of environment 102. Hence, in such an example, mobile station 104 may be able to acquire signal 109-2 whilst located within such portion of example environment 102. Here, for example, an expected service range for BS 108-2 may be less than an expected service range for BS 108-1 in the preceding example.

In yet another example, in certain instances, BS 108-2 may comprise a terrestrial-based transmitting device that may be classified as a local range BS (e.g., a local range base station in a WCDMA/LTE system, a pico base transceiver station in a GSM system, a pico cell in a cdma2000 system, etc.) having an expected service range that extends over a portion of environment 102. Hence, in such an example, mobile station 104 may be able to acquire signal 109-2 whilst located within such portion of example environment 102. Here, for example, an expected service range for BS 108-2 classified as a local area BS may, in certain instances, be less than an expected service range for BS 108-2 classified in the preceding example as a medium range BS.

In still another example, in certain instances, BS 108-n may comprise a transmitting device that may be classified as a femto BS (e.g., a Home Node B (HNB) in a WCDMA system, a Home eNode B (HeNB) in a LTE system, a femto cell in GSM, a femto cell in a cdma2000 system, etc.) having an expected service range that extends over an even smaller region of environment 102. Hence, in such an example, mobile station 104 may be able to acquire signal 109-n while located nearby BS 108-n. Thus, for example, an expected service range for BS 108-n classified as a femto BS may, in certain instances, be less than an expected service range for BS 108-2 classified in the preceding examples as either a medium range BS or local area BS.

In certain example implementations, a terrestrial-based transmitting device may be arranged/enabled to provide various forms of connectivity, processing, services, etc., to mobile device 104 and/or to one or more other devices. For example, as mentioned in previous examples, in certain instances a terrestrial-based transmitting device may support various cellular networks/services. In certain implementations, a terrestrial-based transmitting device may alternatively or additionally support various other networks/services, such as, for example, various wireless network communication and related services, e.g., possibly serving, at least in part, as access point devices, beacon transmitting devices, and/or the like.

As illustrated in FIG. 1, BS 108-n may be connected over communication link 109 to one or more networks 110, which may be further connected over communication link 113 to one or more other devices 112. While communication links 109 and 113 are illustrated as comprising wired communication links, it should be understood that in certain instances communication links 109 and/or 113 may comprise wired and/or wireless communication links. Indeed, for example, network(s) 110 are further illustrated as possibly being able to communicate with one or more other devices in arrangement 100 via a represented wireless communication link 111. Accordingly, although not specifically shown, it should be understood that BS 108-1 and BS 108-2 may be connected to network(s) 110 and/or other device(s) 112 via one or more communication links (wired, and/or wireless).

Network(s) 110 is intended to represent all or part of one or more other electronic devices and/or communication facilities and/or resources capable of supporting wired and/or wireless electronic communication. Thus for example, network(s) 110 may comprise all or part of a telephone network, a cellular telephone network, a wireless communication network, an intranet, the Internet, and/or the like or some combination thereof.

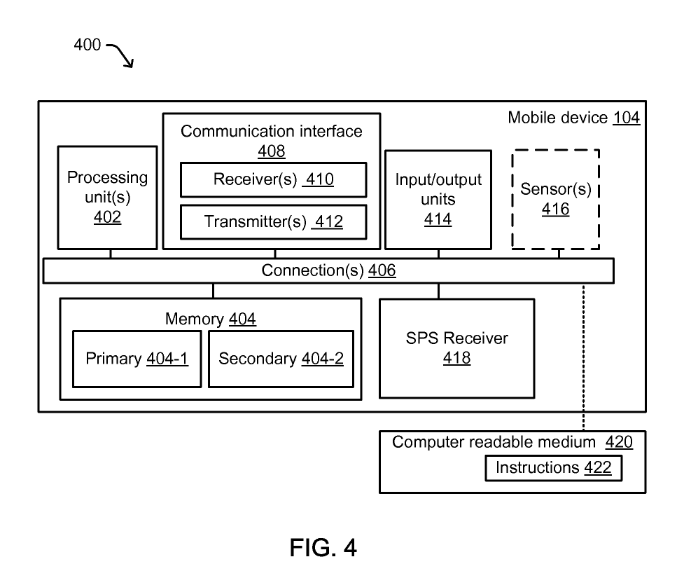

In certain instances environment 102 may comprise an indoor space or even possibly a portion of the outdoor space in which one or more satellite positioning system (SPS) signals 134 transmitted by one or more space vehicles (SVs) 132 of one or more SPS systems 130 may be unreliable or unavailable at times due to various interfering structures, objects, etc. Accordingly, it may be necessary at times for mobile device 104 to search for and attempt to acquire/re-acquire one or more SPS signals 134. As described in greater detail herein, various example techniques are provided herein that may be implemented, for example, in apparatus 106, to determine an SPS signal search space. In accordance with certain aspects, it may be useful to increase or decrease such an SPS signal search space based, at least in part, on a frequency uncertainty corresponding to a classification selected/determined for a terrestrial-based transmitting device in which a receiver (see, for example, SPS receiver 418 in FIG. 4) in mobile device 104 may be adjusted in some manner based on a signal acquired from that particular terrestrial-based transmitting device. For example, let us assume that mobile device 104 is to attempt to acquire SPS signals 134 and that mobile device 104 may be in communication with BS 108-1. Mobile device 104 may, for example, acquire one or more signals via communication link 109-1 from BS 108-1, which may be used to adjust SPS receiver 418 (FIG. 4) applying known techniques. For example, a timing circuit and/or oscillator circuit may be adjusted or otherwise affected based on a carrier signal and/or the like obtained from one or more signals transmitted by BS 108-1. However, as a result of such adjustment(s) a frequency uncertainty corresponding to BS 108-1 may be passed on in some manner to the receiver (SPS receiver 418) in mobile device 104, which may in turn affect a subsequent SPS signal search/acquisition process.

However, by classifying the terrestrial-based transmitting device it may be possible to identify a corresponding frequency uncertainty, which may be considered, at least in part, in determining an SPS signal search space. Thus, in certain instances, an SPS signal search space may take a first form in response to a first frequency uncertainty, a second form in response to a second frequency uncertainty, a third form in response to a third frequency uncertainty, etc. By way of example, one or more boundaries of an SPS signal search space may be increased or decreased based, at least in part, on a magnitude or other like aspect of a particular frequency uncertainty. By determining an SPS signal search space in such a manner, it may be possible for mobile device 104 to better adapt the use of processing resources, which may possibly speed up acquisition of SPS signal(s), reduce power consumption, and/or provide a potential for other beneficial results.

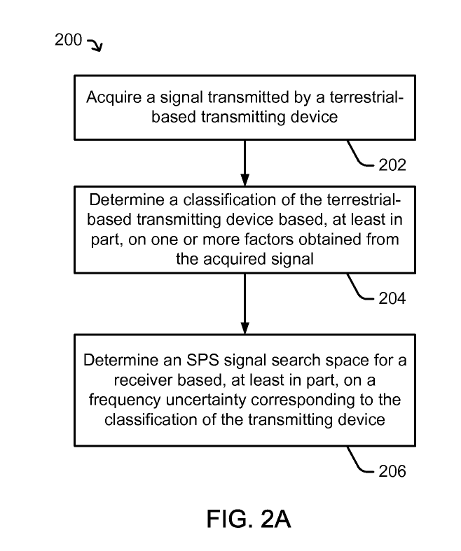

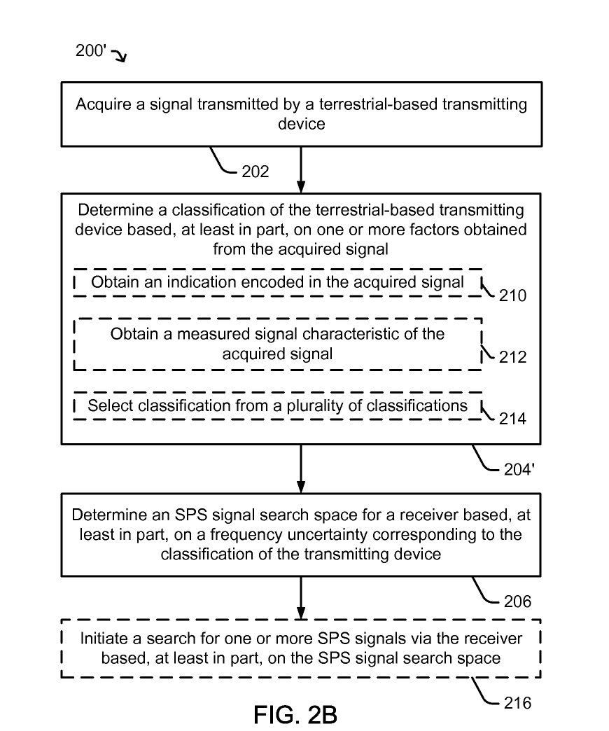

Attention is drawn next to FIG. 2A, which is a flow diagram illustrating an example process 200 that may be implemented to determine a classification of a terrestrial-based transmitting device and determine an SPS signal search space based, at least in part, on such classification. By way of example, process 200 may be implemented in whole or in part by mobile device 104 and/or apparatus 106 provisioned therein.

At example block 202, a mobile device may acquire one or more wireless signals transmitted by a terrestrial-based transmitting device. As mentioned, all or part of such acquired signals may, for example, be used by the mobile device to affect or otherwise adjust a receiver of the mobile device for an attempt to acquire one or more SPS signals.

At example block 204, a classification of the terrestrial-based transmitting device may be determined based, at least in part, on one or more factors that may be obtained from all or part of one or more of the acquired signals at block 202. As mentioned, in certain instances, all or part of one or more factors may be encoded in one or more of the acquired signals and obtained, for example, by decoding or otherwise processing such signal(s). In certain instances, all or part of one or more factors may be obtained as one or more measured signal characteristics of all or part of one or more acquired signals.

At example block 206, an SPS signal search space for a receiver in the mobile device may be determined based, at least in part, on a frequency uncertainty and/or other useful parameter corresponding to the classification of the transmitting device. As mentioned, a form of an SPS signal search space may be different depending, at least in part, on the frequency uncertainty and/or other useful parameter corresponding to the classification of the transmitting device.

Attention is drawn next to FIG. 2B, which is a flow diagram illustrating an example process 200′ that may be implemented to determine a classification of a terrestrial-based transmitting device and determine an SPS signal search space based, at least in part, on such classification. By way of example, process 200′ may be implemented in whole or in part by mobile device 104 and/or apparatus 106 provisioned therein. In caparison with process 200 of FIG. 2A, example process 200′ comprises additional example blocks 210, 212, 214, and 216, wherein example blocks 210, 212 and 214 may, in certain instances, be performed as part of example block 204′.

At example block 202, a mobile device may acquire one or more wireless signals transmitted by a terrestrial-based transmitting device. All or part of such acquired signals may, for example, be used by the mobile device to affect or otherwise adjust a receiver of the mobile device for an attempt to acquire one or more SPS signals.

At example block 204′, a classification of the terrestrial-based transmitting device may be determined based, at least in part, on one or more factors that may be obtained from all or part of one or more of the acquired signals at block 202.

At example block 210, in certain instances, all or part of one or more factors that may be encoded in one or more of the acquired signals may be obtained, for example, by decoding or otherwise processing such signal(s). As described in greater detail herein, in certain instances one or more indicators may be obtained from a signal that may be indicative (expressly or otherwise) as to how one might classify the source terrestrial transmitting device. For example, in certain instances an indicator may be encoded in a transmitted message that expressly or otherwise indicates a transmit power setting of the terrestrial-based transmitting device, which may be indicative of a selectable classification. For example, in certain instances an indicator may be encoded in a transmitted message that expressly or otherwise indicates some identifier or particular feature/aspect of the terrestrial-based transmitting device, which may be indicative of a selectable classification.

At example block 212, in certain instances, all or part of one or more factors may be obtained as one or more measured signal characteristics of all or part of one or more acquired signals. As described in greater detail herein, in certain instances one or more received power level measurements, time propagation measurements, and/or the like or some combination thereof may be obtained from one or more acquired signals, and which alone or in combination with other information such as the transmit power may be indicative (expressly or otherwise) as to how one might classify the source terrestrial transmitting device. For example, in certain instances one or more measured signal characteristics may compared to one or more applicable thresholds (e.g., static or dynamical values, ranges, etc.) that may correspond to a selectable classification.

At example block 214, in certain instances a classification may be selected from a plurality of classification. For example, as mentioned, in certain implementations selectable classifications for a terrestrial-based transmitting device may comprise a wide area BS classification, a medium range BS classification, a local area BS classification, a femto BS classification, a non-femto BS classification, an unknown BS classification, just to name a few non-examples. As with all of the examples presented herein, claimed subject matter is not necessarily intended to be so limited.

At example block 206, an SPS signal search space for a receiver in the mobile device may be determined based, at least in part, on a frequency uncertainty and/or other useful parameter corresponding to the classification of the transmitting device. As mentioned, a form of an SPS signal search space may be different depending, at least in part, on the frequency uncertainty and/or other useful parameter corresponding to the classification of the transmitting device.

At example block 216, a search for one or more SPS signals may be initiated and/or other performed based, at least in part, on the SPS signal search space as determined at example block 216.

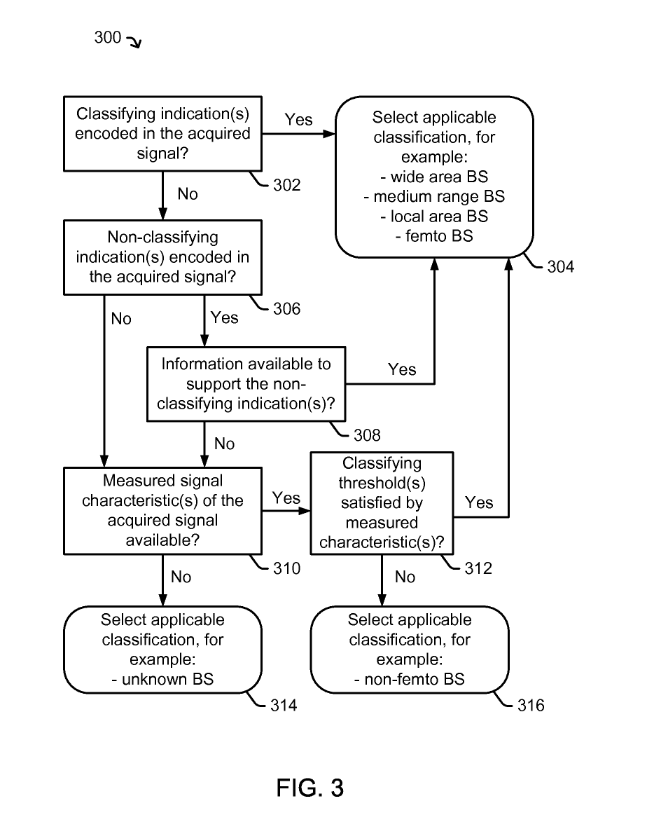

Attention is drawn next to FIG. 3, which is process flow diagram illustrating an example process that may be implemented using a mobile device, for example, as in FIG. 1, to possibly select between a plurality of classifications that may be determined for a terrestrial-based transmitting device based on one or more acquired signals. By way of example, process 300 may be implemented in whole or in part by mobile device 104 and/or apparatus 106 provisioned therein. By way of example, process 300 may be implemented in whole or in part at example block 204 (FIG. 2A), example blocks 204′, 210, 212 and/or 214 (FIG. 2B).

At example block 302, a determination may be made as to whether there may be any classifying indication(s) encoded or otherwise provided in one or more acquired signals from a terrestrial-based transmitting device. Here, for example, a “classifying” indication may comprise information that may (expressly or otherwise more directly) indicate that the terrestrial-based transmitting device matches a particular classification. For example, in certain instances the terrestrial-based transmitting device may encode information in one or more fields of a message, header, etc., that may indicate a particular feature/aspect of the terrestrial-based transmitting device which appears to match criteria corresponding to a particular selectable classification. One obvious technique may be for the obtained classifying indication to simply (expressly) identify a particular selectable classification. For example, if a particular selectable classification is “wide area BS”, a classifying indication may simply indicate such, e.g., by name or some corresponding value. Another technique may be for the obtained classifying indication to identify some other information, such as, for example, a transmitted signal power value or the like, which may by its nature allow one to infer that the terrestrial-based transmitting device matches some criteria for a particular classification. For example, criteria (e.g., threshold values, ranges, etc.) for a selectable “wide area BS” may indicate a transmitted power level reported by the terrestrial-based transmitting device to be greater than value A (or possibly between values A and B).

In a particular example, a message structure (shown below from the 3^{rd} Generation Partnership Project Technical Specification 36.331 (3GPP TS 36.331)) shows that a System Information Block 2 (SIB2) may indicate a “referenceSignalPower” integer value (i.e., between −60 and 50).

```
    SystemInformationBlockType2 ::= SEQUENCE {
    ac-BarringInfo SEQUENCE {
    ac-BarringForEmergency BOOLEAN,
    ac-BarringForMO-Signalling AC-BarringConfig OPTIONAL, --
    Need OP
    ac-BarringForMO-Data AC-BarringConfig OPTIONAL -- Need OP
    } OPTIONAL, -- Need OP
    radioResourceConfigCommon RadioResourceConfigCommonSIB,
    ue-TimersAndConstants UE-TimersAndConstants,
    .
    .
    .
    }
RadioResourceConfigCommonSIB ::= SEQUENCE {
rach-ConfigCommon RACH-ConfigCommon,
bcch-Config BCCH-Config,
pcch-Config PCCH-Config,
prach-Config PRACH-ConfigSIB,
pdsch-ConfigCommon PDSCH-ConfigCommon,
    pusch-ConfigCommon PUSCH-ConfigCommon,
    pucch-ConfigCommon PUCCH-ConfigCommon,
    soundingRS-UL-ConfigCommon SoundingRS-UL-ConfigCommon,
    uplinkPowerControlCommon UplinkPowerControlCommon,
    ul-CyclicPrefixLength UL-CyclicPrefixLength,
    ...,
    [[ uplinkPowerControlCommon-v1020
    UplinkPowerControlCommon-v1020
    OPTIONAL -- Need OR
    ]]
    }
    PDSCH-ConfigCommon ::= SEQUENCE {
    referenceSignalPower INTEGER (−60..50),
    p-b INTEGER (0..3)
    }
```

Thus, for example, a referenceSignalPower in a Sib2 field may correspond to an integer value representative of a transmit power level. Based on current example standards agreements (for example as shown below in Table 1), and/or possibly government regulations, etc., there may be limits on transmit power to certain example classifications of terrestrial-based transmitting devices (again claimed subject matter is not necessarily intended to be so limited):

TABLE 1

| Example Classification | PRAT (Rated Output Power) |
|---|---|
| Wide area BS | No upper limit (typical 46 dBm = 40 W) |
| Medium range BS | ≦38 dBm |
| Local Area BS | ≦24 dBm |
| Home BS (Femto) | ≦20 dBm for 1 antenna port; |
| | ≦17 dBm for 2 antenna ports; |
| | ≦14 dBm for 4 antenna ports; |
| | ≦11 dBm for 8 antenna ports |

Accordingly, if the decision at block 302 is “yes”, then process 300 may proceed to example block 304, wherein an applicable classification may be selected. Here, by way of a non-limiting example, a classification may be selected from a wide area BS, a medium range BS, a local BS, or a femto BS, based, at least in part, on one or more classifying indications. Process 300 may then end. Conversely, if the decision at block 302 is “no”, then process 300 may proceed to example block 306.

At example block 306, a determination may be made as to whether there may be any non-classifying indication(s) encoded or otherwise provided in one or more acquired signals from a terrestrial-based transmitting device. Here, for example, a “non-classifying” indication may comprise information that may indicate whether the terrestrial-based transmitting device matches one or more potential classifications.

For example, in certain instances the terrestrial-based transmitting device may encode information in one or more fields of a message, header, etc., that may indicate a particular intended subscriber, group, etc., to be supported of the terrestrial-based transmitting device. In a particular example, a closed subscriber group (CSG) parameter of a UMTS/LTE system and/or some other form of identification may be obtained, which may suggest or otherwise promote (or conversely act to eliminate or reduce) one or more selectable classifications. For example, a CSG parameter may indicate that a particular selectable classification “femto BS” may be appropriate as possibly indicating that the terrestrial-based transmitting device may comprise a closed/hybrid mode home base station (e.g., HNB, HeNB, etc.). In another example, in certain instances the terrestrial-based transmitting device may encode information in one or more fields of a message, header, etc., that may indicate a particular terrestrial-based transmitting device, model, manufacturer, service provider, certain transmitter features/aspects, etc., that may be applicable to (or not applicable to) the terrestrial-based transmitting device. For example, a network identifier, the frequency, the Location Area Code and Primary Scrambling Code in WCDMA, the Tracking Area Code and Physical CellID in LTE and/or the like may be provided that may serve as evidence for or possibly against selecting one or more classifications.

Accordingly, if the decision at block 306 is “yes”, then process 300 may proceed to example block 308, wherein a further determination may be made as to whether information is available which may be used to support (e.g., corroborate, test, buttress, etc.) the non-classifying indication(s). As shown, if the decision at block 308 is “yes”, then process 300 may proceed to example block 304, wherein an applicable classification may be selected. Here, by way of a non-limiting example, a classification may be selected from a wide area BS, a medium range BS, a local BS, or a femto BS, based, at least in part, on one or more non-classifying indications. Process 300 may then end.

If the decision at either block 306 or block 308 is “no”, then process 300 may proceed to example block 310. At example block 310, a decision may be made as to whether one or more measured signal characteristics obtained from one or more of the acquired signals may be available. In certain instances, the mobile device may perform all or part of certain signal measurements. In certain instances, another device (for example, the terrestrial-based transmitting device) may perform all or part of certain signal measurements. In certain implementations, one or more such measured signal characteristics may be obtained from one or more of the acquired signals as part of block 310. By way of some non-limiting examples, in certain implementations, a measured signal characteristic may comprise or otherwise be based, at least in part, on a measured signal power (e.g., a Received Signal Strength Indicator (RSSI), a Reference Signal Received Power (RSRP), etc.), a measured propagation and/or processing time/delay (e.g., a Timing Advance (TA), a Round Trip Time (RTT), etc.), and/or other like measurable characteristics that may be indicative of a path loss, a range, etc., or some combination thereof.

In one particular embodiment, a carrier may allocate a range of symbols or values (e.g., physical cell ID (PCIs)) to a particular type of cellular transceivers. For example, such a carrier may allocate one range of PCIs to femto cell transceivers and allocate a second range of PCIs to cellular base stations serving macrocells. In a particular implementation, block 308 may access (e.g., via a locally stored database) an indication of how a particular carrier has allocated ranges of PCIs among different classifications of transceiver (e.g., according to the example above). With the identity of the particular carrier, a classification of a terrestrial-based transmitting device may be determined based, at least in part, on whether a particular symbol or value obtained from an acquired signal is within a range of symbols or values allocated to a particular classification of terrestrial-based transmitting devices. Here, block 308 may first identify the particular carrier operator transmitting an acquired signal and then, based on the identified carrier, obtain an indication of how that particular carrier operator has allocated ranges of PCIs among different classifications of transceivers.

As mentioned, it may be possible for such measured signal characteristics as evidence in determining/selecting a classification for the terrestrial-based transmitting device. Hence, if the decision at block 310 is “yes”, then process 300 may proceed to example block 312. However, if the decision at block 310 is “no”, then process 300 may proceed to example bloc 314.

At example block 312, a decision may be made as to whether one or more measured signal characteristics may or may not satisfy one or more applicable “classifying” thresholds. For example, a classifying threshold may correspond to a value or range of a measured signal characteristic that may be indicative as to whether the terrestrial-based transmitting device is more likely to correspond to one or more classifications. Thus, for example, it may be possible to determine, at block 312, whether a terrestrial transmitting device is more or less likely to be classified as a femto BS (hence, answer to block 312 may be “yes”), or conversely as a non-femto BS (hence, answer to block 312 may be “no”).

If the decision at block 312 is “yes”, then process 300 may proceed to example block 304, wherein an applicable classification may be selected. Here, by way of a non-limiting example, a classification may be selected from a wide area BS, a medium range BS, a local BS, or a femto BS, based, at least in part, on one or more non-classifying indications. Process 300 may then end.

If the decision at block 312 is “no”, then process 300 may proceed to example block 316, wherein an applicable classification, e.g., of non-femto BS and/or the like, may be selected. Process 300 may then end.

Returning to block 310, if the decision is “no”, then process 300 may proceed to example bloc 314, wherein an applicable classification, e.g., of unknown BS and/or the like (default) may be selected. Process 300 may then end.

Consequently, a classification for a terrestrial-based transmitting device may be determined/selected (e.g., per example blocks 206 (FIGS. 2A and 2B), and/or example blocks 304, 314 or 316 (FIG. 3)), based, at least in part, on one or more factors obtained from one or more acquired signals. In accordance with an aspect of the techniques provided herein, a frequency uncertainty or other like or useful parameter may be identified as corresponding to the selected classification. Such a frequency uncertainty or other like or useful parameter(s) may be static or dynamically maintained, determined based on external testing possibly with other devices, learned over time, represented by one or more functions, may vary depending upon certain other considerations (e.g., a local mobile device temperature, motion of the mobile device, certain environmental conditions that may affect transmissions/circuits, changes in the industry/standards, etc.).

By way of an example, as shown below in Tables 2-4 in certain instances a (relative) frequency uncertainty may represent current (standards/agreements) frequency error minimum requirements to which certain example classifications of terrestrial-based transmitting devices may be designed/intended to follow (again claimed subject matter is not necessarily intended to be so limited):

TABLE 2

| Example Classification | Frequency Error Minimum |
|---|---|
| (WCDMA/LTE) | Requirement |
| Wide area BS | ±0.05 ppm |
| Medium range BS | ±0.1 ppm |
| Local area BS | ±0.1 ppm |
| Home BS (Femto, HNB, HeNB) | ±0.25 ppm |

TABLE 3

| Example Classification | Frequency Error Minimum |
|---|---|
| (GSM) | Requirement |
| Macro BTS | ±0.05 ppm |
| Pico BTS | ±0.1 ppm |

TABLE 4

| Example Classification | Frequency Error Minimum |
|---|---|
| (cdma2000) | Requirement |
| Macro Cell | ±0.05 ppm |
| Pico Cell | ±0.1 ppm |
| Femto Cell | ±0.1 ppm |

Attention is now drawn to FIG. 4, which is a schematic diagram illustrating certain features of an example special purpose computing platform 400 that may be provisioned within a mobile device 104 and/or apparatus 106, in accordance with certain example implementation.

As illustrated special computing platform 400 may comprise one or more processing units 402 (e.g., to perform data processing in accordance with certain techniques provided herein) coupled to memory 404 via one or more connections 406 (e.g., one or more electrical conductors, one or more electrically conductive paths, one or more buses, one or more fiber-optic paths, one or more circuits, one or more buffers, one or more transmitters, one or more receivers, etc.). Processing unit(s) 402 may, for example, be implemented in hardware or a combination of hardware and software. Processing unit(s) 402 may be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, or the like, or any combination thereof. Processing unit(s) 402 may, for example, perform computer implementable instructions corresponding to one or more applications(s).

Memory 404 may be representative of any data storage mechanism. Memory 404 may include, for example, a primary memory 404-1 and/or a secondary memory 404-2. Primary memory 404-1 may comprise, for example, a random access memory, read only memory, etc. While illustrated in this example as being separate from the processing units, it should be understood that all or part of a primary memory may be provided within or otherwise co-located and coupled with processing unit 402 or other like circuitry within mobile device 104. Secondary memory 404-2 may comprise, for example, the same or similar type of memory as primary memory and/or one or more data storage devices or systems, such as, for example, a disk drive, an optical disc drive, a tape drive, a solid motion state memory drive, etc.

In certain implementations, secondary memory may be operatively receptive of, or otherwise configurable to couple to, a non-transitory computer readable medium 420. Memory 404 and/or non-transitory computer readable medium 420 may comprise instructions 422 for use in performing data processing, e.g., in accordance with the applicable techniques as provided herein.

Special purpose computing platform 400 may, for example, further comprise one or more communication interface 408. Communication interface 408 may, for example, comprise one or more wired and/or wireless network interface units, radios, modems, etc., represented here by one or more receivers 410 and one or more transmitters 412. It should be understood that in certain implementations, communication interface 408 may comprise one or more transceivers, and/or the like. Further, it should be understood that although not shown, communication interface 408 may comprise one or more antennas and/or other circuitry as may be applicable given the communication interface capability.

In accordance with certain example implementations, communication interface 408 may, for example, be enabled for use with various wired communication networks, e.g., such as telephone system, a local area network, a wide area network, a personal area network, an intranet, the Internet, etc.

In accordance with certain example implementations communication interface 408 may, for example, be enabled for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMBP capability), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMAX, Ultra Mobile Broadband (UMB), and/or the like. Additionally, communication interface(s) 408 may further provide for infrared-based communications with one or more other devices. A WLAN may, for example, comprise an IEEE 802.11x network, and a WPAN may comprise a Bluetooth network, an IEEE 802.15x, for example. Wireless communication implementations described herein may also be used in connection with any combination of WWAN, WLAN or WPAN.

Mobile device 104 may, for example, further comprise one or more input and/or output units 414. Input and/or output units 414 may represent one or more devices or other like mechanisms that may be used to obtain inputs from and/or provide outputs to one or more other devices and/or a user. Thus, for example, input and/or output units 414 may comprise various buttons, switches, a touch pad, a trackball, a joystick, a touch screen, a keyboard, a microphone, a camera, and/or the like, which may be used to receive one or more user inputs. In certain instances, input and/or output units 414 may comprise various devices that may be used in producing a visual output, an audible output, and/or a tactile output for a user. For example, input and/or output units 414 may be used to present a video display, graphical user interface, positioning and/or navigation related information, visual representations of electronic map, routing directions, etc., via a display mechanism and/or audio mechanism.

Mobile device 104 may, for example, comprise one or more sensors 416. For example, sensor(s) 416 may represent one or more environmental sensors, such as, e.g., a magnetometer or compass, a barometer or altimeter, etc., and which may be useful for positioning. For example, sensor(s) 416 may represent one or more inertial sensors, which may be useful in detecting certain movements of mobile device 104. Thus for example, sensor(s) 416 may comprise one or more accelerometers, one or one or more gyroscopes. Further, in certain instances sensor(s) 416 may comprise and/or take the form of one or more input devices such as a microphone, a camera, a light sensor, etc.

SPS receiver 418 may be capable of acquiring and acquiring SPS signals 134 via one or more antennas (not shown). SPS receiver 418 may also process, in whole or in part, SPS signals 134 for estimating a position and/or a motion of mobile device 104. In certain instances, SPS receiver 418 may comprise one or more processing unit(s) (not shown), e.g., one or more general purpose processors, one or more digital signal processors DSP(s), one or more specialized processors that may also be utilized to process acquired SPS signals, in whole or in part, and/or calculate an estimated location of mobile device 104. In certain implementations, all or part of such processing of acquired SPS signals may be performed by other processing capabilities in mobile device 104, e.g., processing unit(s) 402, memory 404, etc., in conjunction with SPS receiver 418. Storage of SPS or other signals for use in performing positioning operations may be performed in memory 404 or registers (not shown).

In certain instances, sensor(s) 416 may generate analog or digital signals that may be stored in memory 404 and processed by DPS(s) (not shown) or processing unit(s) 402 in support of one or more applications such as, for example, applications directed to positioning or navigation operations based, at least in part, on one or more positioning functions.

Processing unit(s) 402 may comprise a dedicated modem processor or the like that may be capable of performing baseband processing of signals acquired and downconverted at receiver(s) 410 of communication interface 408 or SPS receiver 418. Similarly, a modem processor or the like may perform baseband processing of signals to be upconverted for transmission by (wireless) transmitter(s) 412. In alternative implementations, instead of having a dedicated modem processor, baseband processing may be performed by a general purpose processor or DSP (e.g., general purpose and/or application processor). It should be understood, however, that these are merely examples of structures that may perform baseband processing, and that claimed subject matter is not limited in this respect. Moreover, it should be understood that the example techniques provided herein may be adapted for a variety of different electronic devices, mobile devices, transmitting devices, environments, position fix modes, etc.

In particular implementations, the above described features of mobile device 104 may perform one or more actions set forth in process 200 shown in FIG. 2A. For example, actions to acquire a signal at block 202 may be performed at receiver(s) 410 of communication interface 408. Processing unit(s) 402 in combination with memory 404 may determine a classification of a transmitting device transmitting the acquired signal at block 204. For example, processing unit(s) 402 in combination with memory 404 may determine such a classification based, at least in part, one or more factors of the signal acquired at block 202. Processing unit(s) 402 in combination with memory 404 may then perform on or more actions set forth in block 206 to determine an SPS signal search space for a receiver (e.g., SPS receiver 418) based, at least in part, on a frequency uncertainty corresponding to the classification of the transmitting device.

The techniques described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically motion stated otherwise, as apparent from the following discussion, it is appreciated that throughout this specification discussions utilizing terms such as “processing”, “computing”, “calculating”, “determining”, “generating”, “obtaining”, “modifying”, “selecting”, “identifying”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method comprising, at a mobile device:
acquiring a signal transmitted by a terrestrial-based transmitting device;
determining a classification of said terrestrial-based transmitting device based, at least in part, on one or more factors obtained from said acquired signal; and
determining a satellite positioning system (SPS) signal search space for a receiver based, at least in part, on a frequency uncertainty corresponding to said classification of said terrestrial-based transmitting device.

2. The method as recited in claim 1, wherein said one or more factors are based, at least in part, on: (i) an indication encoded in said acquired signal; or (ii) a measured signal characteristic of said acquired signal; or (iii) a combination of (i) and (ii).

3. The method as recited in claim 1, wherein said one or more factors comprise a symbol or value, and wherein determining a classification of said terrestrial-based transmitting device further comprises determining whether said symbol or value is within a range of symbols or values allocated to a particular classification of terrestrial-based transmitting devices.

4. The method as recited in claim 3, wherein the symbol or value comprises a physical cell identifier (PCI).

5. The method as recited in claim 1, wherein said classification of said terrestrial-based transmitting device is selected from a plurality of classifications corresponding to a plurality of different expected transmitter device quality ratings.

6. The method as recited in claim 5, wherein said frequency uncertainty increases as an expected transmitter device quality rating corresponding to said terrestrial-based transmitting device decreases.

7. The method as recited in claim 1, wherein said classification of said terrestrial-based transmitting device is selected from a group of classifications comprising one or more of: a wide area base station classification, a medium range base station classification, a local area base station classification, a femto base station classification, a non-femto base station classification, or an unknown base station classification.

8. The method as recited in claim 1, and further comprising, at said mobile device, initiating a search for at least one SPS signal via said receiver based, at least in part, on said SPS signal search space.

9. An apparatus for use in a mobile device, the apparatus comprising:
means for acquiring a signal transmitted by a terrestrial-based transmitting device;
means for determining a classification of said terrestrial-based transmitting device based, at least in part, on one or more factors obtained from said acquired signal; and
means for determining a satellite positioning system (SPS) signal search space for a receiver based, at least in part, on a frequency uncertainty corresponding to said classification of said terrestrial-based transmitting device.

10. The apparatus as recited in claim 9, wherein said one or more factors are based, at least in part, on: (i) an indication encoded in said acquired signal; or (ii) a measured signal characteristic of said acquired signal; or (iii) a combination of (i) and (ii).

11. The apparatus as recited in claim 9, wherein said one or more factors comprise a symbol or value, and wherein means for determining a classification of said terrestrial-based transmitting device further comprises means for determining whether said symbol or value is within a range of symbols or values allocated to a particular classification of terrestrial-based transmitting devices.

12. The apparatus as recited in claim 11, wherein the symbol or value comprises a physical cell identifier (PCI).

13. The apparatus as recited in claim 9, wherein said classification of said terrestrial-based transmitting device is selected from a plurality of classifications corresponding to a plurality of different expected transmitter device quality ratings.

14. The apparatus as recited in claim 13, wherein said frequency uncertainty increases as an expected transmitter device quality rating corresponding to said terrestrial-based transmitting device decreases.

15. The apparatus as recited in claim 9, and further comprising means for initiating a search for at least one SPS signal via said receiver based, at least in part, on said SPS signal search space.

16. A mobile device comprising:
a communication interface to acquire a signal transmitted by a terrestrial-based transmitting device; and
a processing unit to:
determine a classification of said terrestrial-based transmitting device based, at least in part, on one or more factors obtained from said signal acquired via said communication interface; and
determine an SPS signal search space for a receiver based, at least in part, on a frequency uncertainty corresponding to said classification of said terrestrial-based transmitting device.

17. The mobile device as recited in claim 16, wherein said one or more factors are based, at least in part, on: (i) an indication encoded in said acquired signal; or (ii) a measured signal characteristic of said acquired signal; or (iii) a combination of (i) and (ii).

18. The mobile device as recited in claim 16, wherein said one or more factors comprise a symbol or value, and wherein said processing unit is configured to determine the classification of said terrestrial-based transmitting device by determining whether said symbol or value is within a range of symbols or values allocated to a particular classification of terrestrial-based transmitting devices.

19. The mobile device as recited in claim 18, wherein the symbol or value comprises a physical cell identifier (PCI).

20. The mobile device as recited in claim 16, wherein said classification of said terrestrial-based transmitting device is selected from a plurality of classifications corresponding to a plurality of different expected transmitter device quality ratings.

21. The mobile device as recited in claim 20, wherein said frequency uncertainty increases as an expected transmitter device quality rating corresponding to said terrestrial-based transmitting device decreases.

22. The mobile device as recited in claim 16, wherein said classification of said terrestrial-based transmitting device is selected from a group of classifications comprising one or more of: a wide area base station classification, a medium range base station classification, a local area base station classification, a femto base station classification, a non-femto base station classification, or an unknown base station classification.

23. The mobile device as recited in claim 16, said processing unit to further initiate a search for at least one of SPS signal via said receiver based, at least in part, on said SPS signal search space.

24. A non-transitory computer readable medium having stored therein computer implementable instructions executable by a processing unit of a mobile device to:
determine a classification of a terrestrial-based transmitting device based, at least in part, on one or more factors obtained from a signal transmitted by said terrestrial-based transmitting device and acquired by said mobile device; and
determine a satellite positioning system (SPS) signal search space for a receiver based, at least in part, on a frequency uncertainty corresponding to said classification of said terrestrial-based transmitting device.

25. The non-transitory computer readable medium as recited in claim 24, wherein said one or more factors are based, at least in part, on: (i) an indication encoded in said acquired signal; or (ii) a measured signal characteristic of said acquired signal; or (iii) a combination of (i) and (ii).

26. The non-transitory computer readable medium as recited in claim 24, wherein said one or more factors comprise a symbol or value, and wherein the instructions are executable by the processing unit to determine the classification of said terrestrial-based transmitting device further by determining whether said symbol or value is within a range of symbols or values allocated to a particular classification of terrestrial-based transmitting devices.

27. The non-transitory computer readable medium as recited in claim 26, wherein the symbol or value comprises a physical cell identifier (PCI).

28. The non-transitory computer readable medium as recited in claim 24, wherein said classification of said terrestrial-based transmitting device is selected from a plurality of classifications corresponding to a plurality of different expected transmitter device quality ratings.

29. The non-transitory computer readable medium as recited in claim 28, wherein said frequency uncertainty increases as an expected transmitter device quality rating corresponding to said terrestrial-based transmitting device decreases.

30. The non-transitory computer readable medium as recited in claim 24, said computer implementable instructions to being further implementable by said processing unit of said mobile device to initiate a search for at least one SPS signal via said receiver based, at least in part, on said SPS signal search space.
